(19) United States
(12) Patent Application Publication
(10) Pub. No.: US 2013/0166647 A1
(43) Pub. Date: Jun. 27, 2013

(54) SYSTEM AND METHOD FOR WEB DATA SHARING

(71) Applicants: Shih-Fang Wong, Tu-Cheng (TW); Xin Lu, Shenzhen City (CN); Yao-Hua Liu, Shenzhen City (CN)

(72) Inventors: Shih-Fang Wong, Tu-Cheng (TW); Xin Lu, Shenzhen City (CN); Yao-Hua Liu, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/418,370

(22) Filed: Mar. 13, 2012

(30) Foreign Application Priority Data
Dec. 22, 2011 (CN) 201110434865.5

(51) Int. Cl. G06F 15/16

(52) U.S. Cl. 709/204

(57) ABSTRACT

A system capable of sharing web data includes a number of clients communicable with each other. The clients communicate with network servers. The client includes a content accessing module, a storage module, a page loading module, and a browser module. The content accessing module accesses web pages on the network servers in response to a user's requests from the client and stores the accessed web pages in the storage module. The stored accessed web pages are accessible by the client and the remaining clients. The page loading module loads web pages from storage modules of the remaining clients. The browser module displays the web pages loaded by the page loading module. A related method is also provided.

### BACKGROUND

1. Technical Field

The present disclosure relates to web data sharing and, particularly, to a system and method capable of sharing web data among a number of clients.

2. Description of the Related Art

When obtaining data stored in servers, clients should load the data to the server via an HTTP protocol. However, if a number of clients load to the server simultaneously, the loading speed of each client will be reduced.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of a system capable of sharing web data among a number of clients in accordance with an exemplary embodiment.

FIG. 2 is a block diagram of the system of FIG. 1 in accordance with an exemplary embodiment.

FIG. 3 is a flowchart illustrating a method of sharing web data applied in the system of FIG. 1, in accordance with an exemplary embodiment.

### DETAILED DESCRIPTION

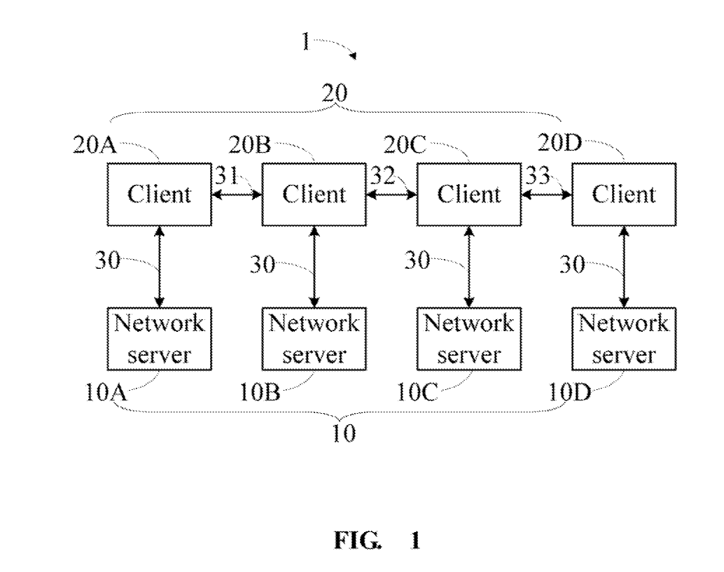

FIG. 1 is a schematic diagram of a system capable of sharing web data among a number of clients. The system 1 includes a number of network servers 10 and a number of clients 20. The network servers 10A, 10B, 10C, and 10D communicate with the clients 20A, 20B, 20C, and 20D via a network 30. The clients 20A, 20B, 20C, and 20D communicate with each other via networks 31-33 respectively. In the embodiment, the network servers 10 are cloud computing servers, and the clients 20 are personal computers.

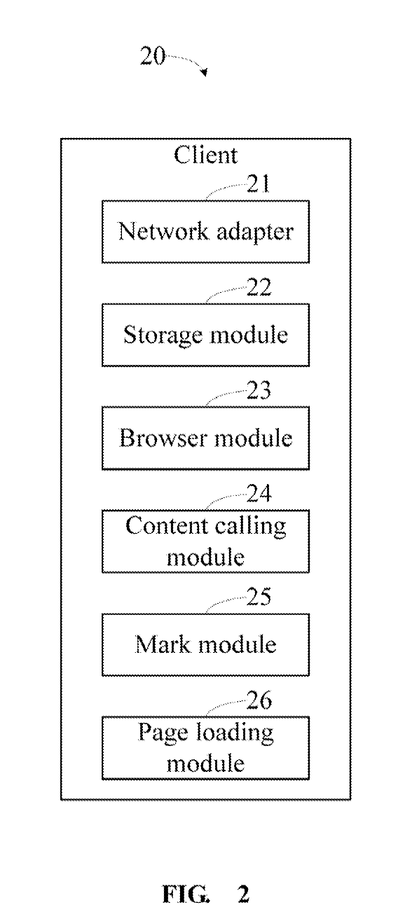

Referring to FIG. 2, each client 20 includes a network adapter 21, a storage module 22, a browser module 23, and a content accessing module 24. The network adapter 21 is configured to connect the client 20 to the corresponding network server 10 of the client 20 via the network 30, and interconnects the clients 20 via the networks 31/32/33. The content accessing module 24 is configured to access web pages of the network server 10 in response to user requests. The browser module 23 is configured to display the web pages on a display (not shown) of the client 20. The storage module 22 is configured to store the web pages. The web page includes web page content, web page parameters, and so on. In the embodiment, each web page is stored to a particular folder of the storage module 22.

In the embodiment, the client 20 further includes a mark module 25 configured to mark web pages that the user of the client 20 want to share with other clients 20 (hereinafter “sharable web pages”). In an embodiment, the mark module 25 adds a sharing label in the web pages of the sharable web pages stored in the storage module 22. For example, the mark module 25 adds the sharable label in titles of the sharable web pages. In an alternative embodiment, the mark module 25 generates a file to record a sharing page list to list each sharable web page. The mark module 25 updates the sharing page list when a new web page obtained from the network server 10 is determined by the user to be a sharable page.

The client 20 further includes a page loading module 26 configured to load web pages from the storage module 22 of another client 20. The browser module 23 displays the loaded web pages. For example, when the client 20A accesses one web page from the corresponding network server 10 and stores the accessed web page in the storage module 22, the content accessing module 24 of the client 20B can obtain the web page stored in the storage module 22 of the client 20A via the network 31, and stores the obtained web page in the storage module 22 of the client 20B.

In the embodiment, the client 20B provides a user interface to display a list of all sharable web pages in the storage module 22 of the client 20A obtained by the content accessing module 24 of the client 20B. The content accessing module 24 of the client 20B selects web pages in response to selection operations of the user, and stores the selected web pages in the storage module 22 of the client 20B. The browser module 23 of the client 20B displays the web pages stored in the storage module 22 of the client 20B, thereby the browser module 23 of the client 20B is capable of accessing the web pages of the network server 10A without accessing the network server 10A.

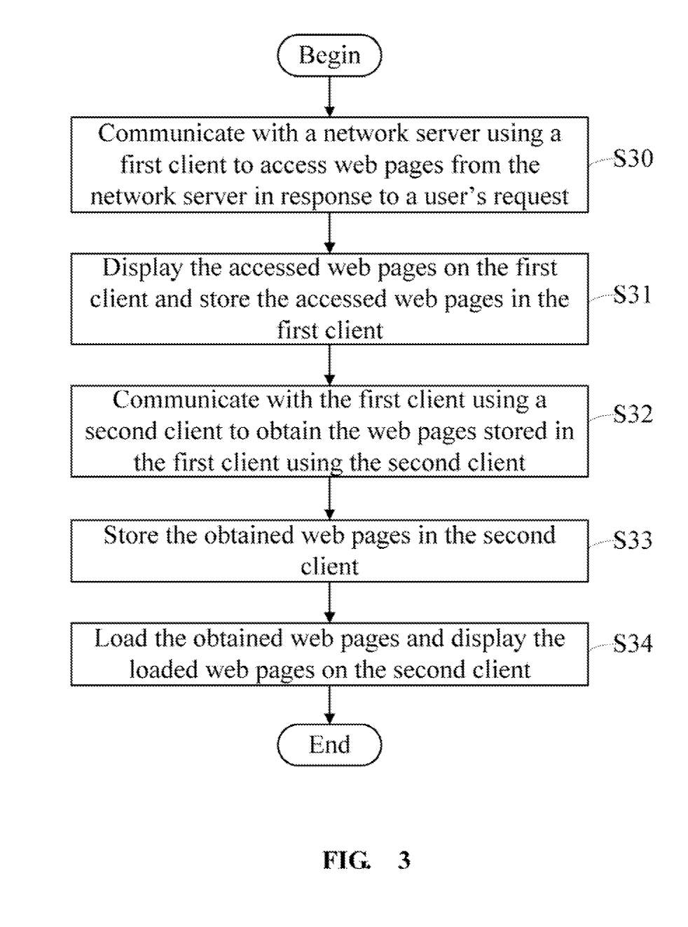

FIG. 3 is a flowchart illustrating a method of sharing web data applied in the system 1.

In step S30, the content accessing module 24 of the client 20A accesses the web pages of the network server 10 in response to a user request.

In step S31, the browser module 23 of the client 20A displays the web pages on the display of the client 20A. The storage module 22 of the client 20A stores the web pages. The web pages include web page content, web page parameters, and so on.

In the embodiment, the mark module 25 adds the sharing label in the web pages of the sharable web pages stored in the storage module 22. For example, the mark module 25 adds the sharing label in the titles of the sharable web pages. In an alternative embodiment, the mark module 25 generates a file to record a sharing page list to list each sharable web page. The mark module 25 updates the sharing page list when a new web page obtained from the network server 10 is determined by the user to be a sharable page.

In step S32, the content accessing module 24 of the client 20B obtains the web pages stored in the storage module 22 of the client 20A via the network 31.

In step S33, the storage module 22 of the client 20B stores the obtained web pages.

In the embodiment, the client 20B provides a user interface to display a list of all sharable web pages in the storage module 22 of the client 20A obtained by the content accessing module 24 of the client 20B. The content accessing module 24 of the client 20B selects web pages in response to selection operations of the user, and stores the selected web pages in the storage module 22 of the client 20B.

In step S34, the page loading module 26 of the client 20B loads the web pages from the storage module 22 of the client 20A, and the browser module 23 of the client 20B displays the loaded web pages.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A system capable of sharing web data comprising:
a number of clients communicable with each other, the clients configured for communicating with network servers, wherein each client comprising:
a content accessing module configured to access web pages on the network servers in response to a user's request from said client;
a storage module configured to store the accessed web pages associated with said client, the stored accessed web pages being accessible by said client and the remaining clients;
a page loading module configured to load web pages from storage modules of the remaining clients; and
a browser module configured to display the web pages loaded by the page loading module.

2. The system capable of sharing web data as recited in claim 1, wherein each web page comprises web page content and web page parameter.

3. The system capable of sharing web data as recited in claim 1, wherein the network servers are cloud computing servers.

4. The system capable of sharing web data as recited in claim 1, wherein the clients are personal computers.

5. The system capable of sharing web data as recited in claim 1, wherein each client further comprises:
a mark module configured to mark web pages that the user of said client want to share with other clients.

6. The system capable of sharing web data as recited in claim 5, wherein the mark module adds a sharing label to the sharable web pages stored in the storage module.

7. The system capable of sharing web data as recited in claim 5, wherein the mark module generates a file to record a sharing page list listing the sharable web pages, and updates the sharing page list when a new web page obtained from the network server is marked by the user as a sharable web page.

8. The system capable of sharing web data as recited in claim 1, wherein each client provides a user interface for displaying web pages stored in the storage modules of the remaining clients and obtained by the content accessing module, and the content accessing module selects web pages in response to a user's selections, and stores the selected web pages in the storage module of said client.

9. A method of sharing web data among clients comprising:
communicating with a network server using a first client to access web pages from the network server in response to a user's request;
displaying the accessed web pages on the first client and storing the accessed web pages in the first client;
communicating with the first client using a second client, and obtaining the web pages stored in the first client using the second client;
storing the obtained web pages in the second client; and
loading the obtained web pages and displaying the loaded web pages on the second client.

10. The method as recited in claim 9, wherein each web page comprises web page content and web page parameter.

11. The method as recited in claim 9, wherein the network server is a cloud computing server.

12. The method as recited in claim 9, wherein the first client and the second client are personal computers.

13. The method as recited in claim 9, wherein the second client provides a user interface for displaying web pages stored in the first client for a user of the second client to select, and stores the selected web pages in the second client.
